(19) United States
(12) Patent Application Publication
(10) Pub. No.: US 2013/0239722 A1
(43) Pub. Date: Sep. 19, 2013

(54) SWIVEL DRIVE

(71) Applicants: Martin Völlner, Hochstadt (DE); Hubertus Frank, Hochstadt (DE); Uwe Klinner, Forchheim (DE)

(72) Inventors: Martin Völlner, Hochstadt (DE); Hubertus Frank, Hochstadt (DE); Uwe Klinner, Forchheim (DE)

(73) Assignee: IMO HOLDING GMBH, Gremsdorf (DE)

(21) Appl. No.: 13/701,745

(22) PCT Filed: May 30, 2011
(86) PCT No.: PCT/EP2011/002658

§ 371 Date: May 23, 2013

(30) Foreign Application Priority Data
Jun. 2, 2011 (DE) 10 2010 022 476.6

(51) Int. Cl. F16H 1/16

(52) U.S. Cl. CPC F16H 1/16
USPC 74/416

(57) ABSTRACT

A device for a rotary drive of a crane, a working platform, a tracking photovoltaic assembly, a heliostat, or the like, for tracking mirrors of a solar thermal power station, etc., on a foundation or chassis, of a heavy duty vehicle, or another part of a machine, comprising a worm gear having a housing having a connecting surface for connecting to a part of a machine or facility, chassis, or a foundation, with a rotatable worm, and a worm wheel rotatably mounted in the housing, wherein there is provided a rolling contact bearing on each side of toothing of the worm wheel engaged with the worm, and a connecting surface for connecting to a part of a machine or facility, to a chassis or a foundation The housing and the worm wheel each formed in one piece, wherein the smallest internal diameter of the housing is larger than the largest external diameter of the worm wheel.

The invention is directed to a so-called swivel drive, that is a device for the rotary drive of a part of a machine or a facility, for example a crane, an elevating working platform, a tracking photovoltaic assembly or a heliostat or the like equipment for tracking mirrors within the context of a solar thermal power station, etc., on a foundation or on a chassis, for example of a heavy duty vehicle, or to another part of a machine or a facility, comprising a worm gear mechanism having a housing, which has a connecting surface for connecting to a part of a machine or a facility, to a chassis or to a foundation, with a worm, which is rotatable manually or by means of a drive motor, and with a worm wheel which is rotatably mounted in the housing, in that there is provided at least one rolling contact bearing on each of both sides of the toothing of the worm wheel provided to engage with the worm, and which comprises a connecting surface for connecting to a part of a machine or a facility, to a chassis or to a foundation.

On the one hand, the housing of a generic swivel device serves for the bearing of the worm wheel and of the worm by means of rolling contact bearings; on the other hand, it shall enclose the toothing area of the worm wheel and of the worm as entirely as possible and thereby shall prevent the intrusion of dirt and other particles, for example. For this reason, known housings for example comprise a base part with a footprint in the shape of a “D”, whereby the worm runs parallel to the secant of the “D”. A cross-section through the lateral surface of such base part has a “D”-like shape, too; thereupon, after installation of the worm and worm wheel, a lid is fitted and is screwed to the base part. Although a recess is provided at both the base part and the lid, by what the worm wheel is accessible for mounting to a part of a machine or a facility, such recesses however are not big enough for inspection of the toothing of the worm wheel. At an inspection of the worm wheel's toothing, therefor the lid has to be disassembled first, what—due to the mutual interpenetration—is impossible, as long as the worm wheel is linked to the connected part of a machine or facility.

From the disadvantages of the described state of the art, the problem initiating the present invention results, to improve a generic for the rotary drive of a first part of a machine or a facility relative to a further part of a machine or a facility, foundation, chassis or the like such that—for example for the purpose of an inspection of the worm wheel's toothing—a disassembling of the housing can be performed with as less effort as possible.

The solution of this problem is accomplished in that at least that area of the housing which is concentric to the swivel axis of the swivel drive, is formed in one piece, wherein the smallest internal diameter of the housing is larger than the largest external diameter of the worm wheel.

This measure aims to entirely avoid a lid, such that a disassembling of the housing does not require a previous removal of a lid. Instead, both parts—the housing on the one hand and the worm wheel on the other hand—can be pulled apart in an axial direction relative to a swivel axis of the swivel drive according to the invention, possibly after previous removal of parts of the (contact roller) bearing.

It has proven favourable that the worm wheel comprises a central recess. By such a recess, the mass of a device according to the invention can be reduced, and thereby its weight, too.

When the central recess traverses the worm wheel entirely, in a built-in state, cables or other conduits can be fed there through from a foundation, chassis or the like to a swiveling part of a facility.

The worm wheel may be fabricated as a cast part, whereby at least one lateral projection for receiving of a worm (each) may be integrated, that means be formed jointly. Such complex shapes may be produced as a cast part with less material input and effort.

Within the scope of the invention, the inner surface of the central recess in the worm wheel follows a conical course. Such a shape facilitates the demoulding of a cast blank.

Preferably, the raceways of the worm wheel for the rolling elements are fabricated out of the same base body as its toothing. Thereby, the manufacturing process can be simplified further.

The toothing of the worm wheel may be adapted to the cross-section of the worm. This is especially the case at a so-called globoid worm wheel, whose toothed reference surface corresponds to a globoid, that is to say to a surface which is generated by rotation of an arc of a circle around an axis, which lies within the same plane than the generating arc of a circle itself.

The invention further provides that the minimum cross-sectional area of the worm wheel in the meshing region is smaller than its connecting surface. Such an arrangement appears especially in the case of a globoid toothing, if this is machined deepend into the cicumferential end face of the worm wheel, and has the advantage that there is only a minimum space required in case of a maximally firm connection to a part of a machine or a facility.

On the other hand, the connecting surface(s) of the worm wheel and/or of the housing should be plane, because plane surfaces may be produced with highest precision, thereby providing a particularly intimate contact with a high frictional coefficient.

The connecting surfaces of the worm wheel and of the housing should lie in planes parallel to each other, so that both can be penetrated rectangularly by the rotational axis of the bearing in a likewise manner.

For producing a stable joint to a part of a machine or of a facility or foundation or chassis to be connected, the invention provides annularly distributed fixing elements in the connecting surface of the worm wheel and/or of the housing. The fixing elements at one, both or all connecting surfaces can be formed as through-bores or as tapped blind holes. If thereby the bottom of such a blind hole is situated at the height of a row of roller elements, in most cases an optimum compromise is found between a minimum design height of the swivel drive according to the invention and a maximum mechanical stability thereof.

Furthermore, the invention is characterized by two angular rolling contact bearings, especially two angular contact ball bearings, which are arranged in the style of a double angular rolling contact bearing, preferably in the style of a double angular contact ball bearing. Preferably, these two rolling contact bearings are braced against each other, so that no relative movement occurs between worm wheel and housing even in case of a varying axial load.

The raceways of the rolling contact bearings should be hardened, especially surface-hardened. Therefor inductive hardening is recommended, but also flame hardening, etc. Thereby, the invention prefers progressive hardening or slip-free hardening. Even a nitriding is possible as well as a combination of such treatments.

According to the invention, the roller elements or balls respectively are held at equidistant positions by a cage or by several cage segments. Thereby, the cage or the cage segments may comprise a two-dimensional, comb-like structure, whereby the free ends of the comb's teeth of both rolling contact bearings are directed vis-à-vis. Such a cage can be inserted subsequently via a bearing gap and can be removed in the same way, without having to disassemble the bearing or the swivel drive according to the invention. So that such a cage or such a cage segment cannot loosen inadvertently, its comb's teeth may comprise indentations, which encompass a roller element to beyond its equator and have to be snapped onto the roller elements indeed, to be held there in a tight fit afterwards.

A further constructional rule according to the invention provides that, in assembled state, the minimum width Wₘᵢₙ of the clear gap between the outer surface of the worm wheel and the inner surface of the housing is equal to or greater than half the value of the diameter D of a roller element: Wₘᵢₙ≧D/2. Thereby, it is achieved that—before the insertion of the roller elements—the worm wheel can be displaced eccentrically relative to the housing, namely at least for an amount of D/2. Thereby, at the circumferential area a gap opens up to a maximum value Wₘₐₓ≧D, and at this site, the roller elements can then be inserted subsequently into the raceways there, without requiring an insertion opening for their own.

For lubricating the rolling contact bearings as well as the toothing within the hollow space of the gap in a durable manner, the gap between the housing and the worm wheel should be sealed at both end faces of the rolling contact bearing.

Thereby, at least one such sealing can be designed as a shaft seal ring, especially as a radial shaft seal ring. This has the advantage that it can subsequently be installed and disassembled if needed, without much effort.

For enhancement of the sealing effect, at least one sealing can comprise a sealing lip, which is pressed tightly against the regarding sealing thrust surface by means of a circumferential tension wire. Such a tension wire can improve the pressing effect of the sealing lip considerably, so that a liquid lubricant like oil may be used in some cases.

It has proved successfully to manufacture the housing as a cast part, so that for example a lateral projection at the housing for receiving the worm can be manufactured in one single working step.

For an easier demoulding of such a cast part, one can grant the outer lateral surface of the housing part surrounding the worm wheel a conical shape, possibly with attached stiffening ribs and/or with a circumferential flange in the area of the connecting surface.

Within the scope of the invention, within a lateral housing projection, a worm is pivoted by means of rolling contact bearings, for example by means of roller bearings and/or by means of ball bearings.

The invention offers the possibility to adjust or minimize the tooth flank clearance between worm wheel and worm. Therewith, an early attrition shall be counteracted, which otherwise would be caused by repeated clashing of the tooth or, respectively, thread areas meshing with each other.

Such a minimizing of the tooth flank clearance can be achieved by the geometry of the worm and/or of the worm thread varying in their longitudinal directions. For example, the worm could have a slightly conical or cone-like basic shape, so that the thread meshing area of the worm extends more or less deep into the tooth gaps of the worm wheel, depending upon the displacement of the worm in its longitudinal direction.

In tracking this thought further, the invention reaches an arrangement, whereby the distance between the flanks of the worm thread varies along the longitudinal direction of the worm, especially according to a duplex worm thread. Owing to slightly different thread leads, the tooth width or, respectively, the width of the thread's elevation of the worm varies along the longitudinal direction thereof. Such an arrangement has improved properties compared to the previously described conical shape of the worm, because the distance between the meshing parts of the gear does not vary and therefore no clamping has to be feared.

Finally, it corresponds to the teaching of the invention, that the position of the worm is variable in its longitudinal direction. This may happen in that the position of the worm is adjusted only at an open end face of the worm projection at the housing, while at the opposite end of the worm, there is provided only a pure radial bearing, without an axially effective force component. In contrast, at the driven end of the worm, where it leaves the housing, a combined radial and axial bearing is provided, for example in the form of a single-row or multiple-row angular rolling contact bearing, preferably in the shape of a double angular rolling contact bearing, especially in the shape of a double angular contact ball bearing. Between the mounting assembly thereof and the housing itself, there can be placed one or more washers or spacer rings, for varying the position of the worm in its longitudinal direction. This can be done first-time upon the manufacturing by the working personnel initially determining the optimum position of the worm for a clearance-free gear combination by way of trial, and then choosing and mounting the appropriate spacer ring. Later, this procedure can be repeated after each maintenance or inspection interval.

Further features, details, advantages and effects on the basis of the invention will become apparent from the following description of a preferred embodiment of the invention as well as from the drawing. Thereby:

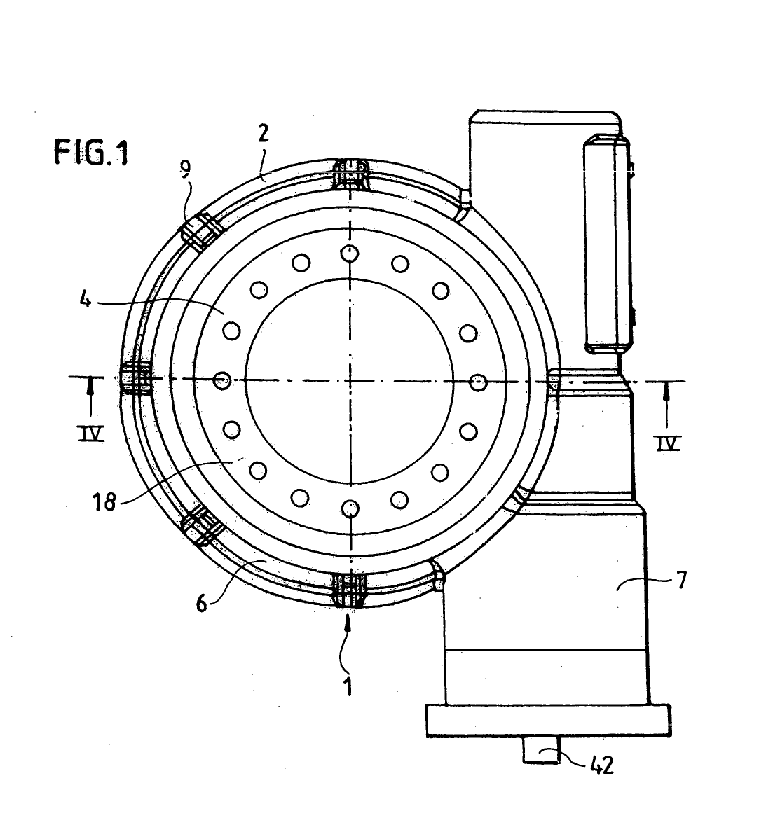

FIG. 1 shows a plan view of a swivel drive according to the invention;

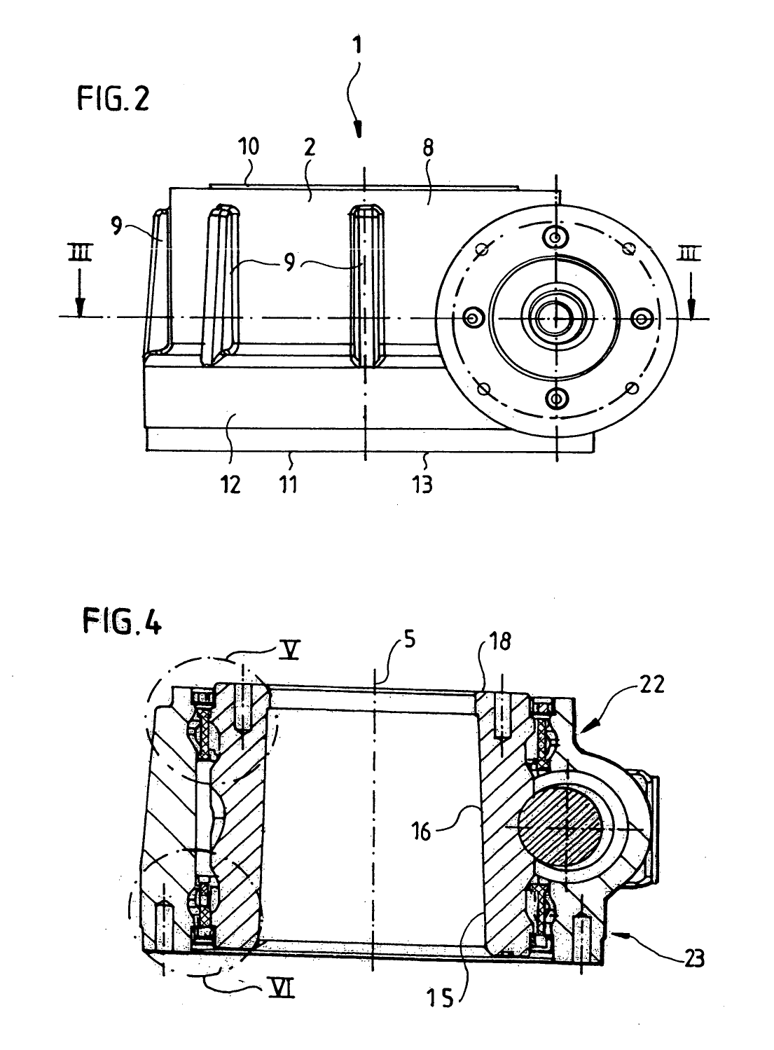

FIG. 2 shows a lateral view of FIG. 1;

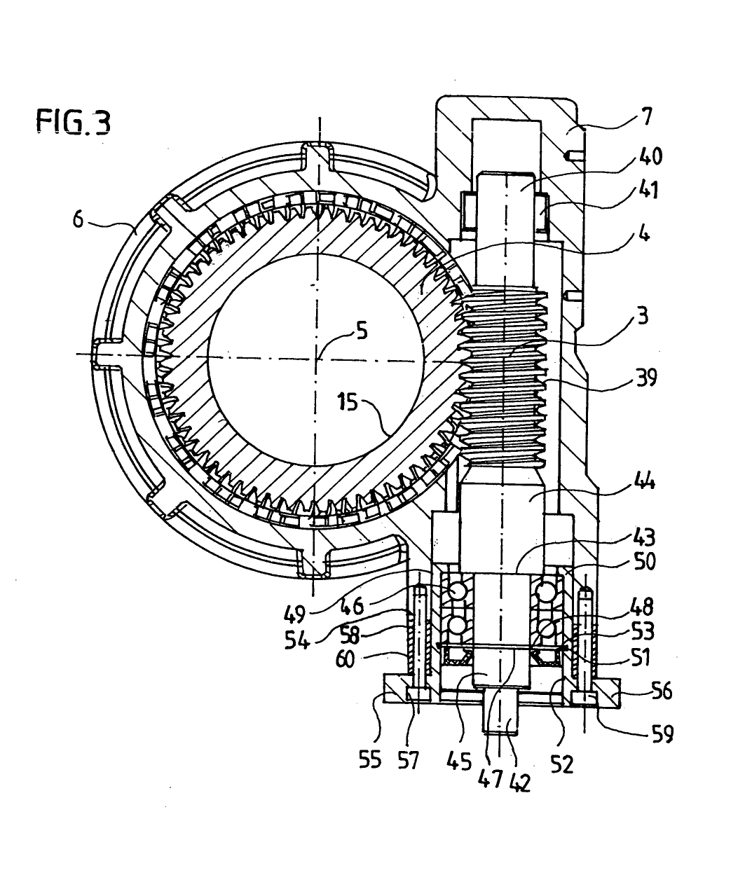

FIG. 3 shows a cross-sectional view traverse through the swivel drive along the line III-Ill of FIG. 2;

FIG. 4 shows a cross-sectional view through FIG. 1 along the line IV-IV;

FIG. 5 shows the detail V of FIG. 4 in an enlarged view; as well as

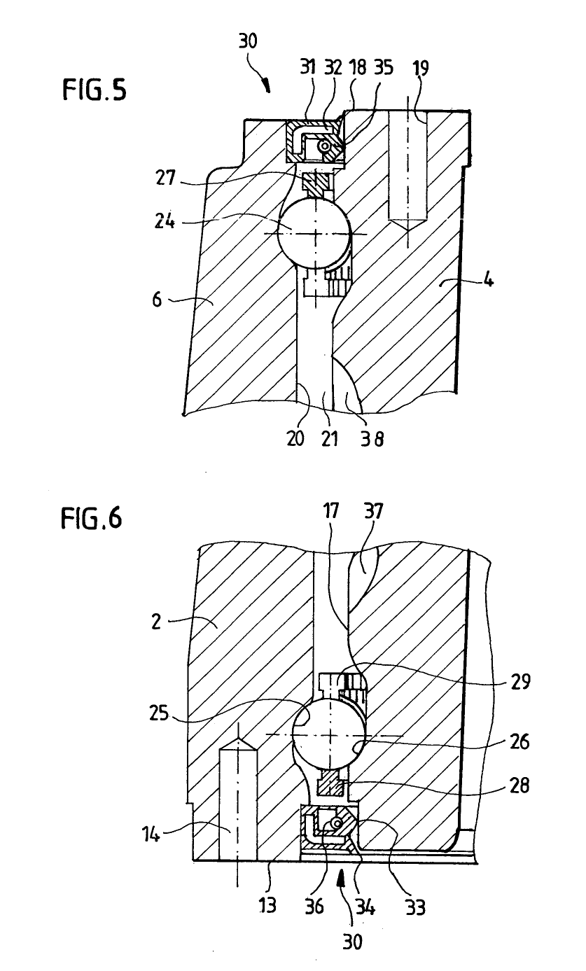

FIG. 6 shows the detail VI of FIG. 4 in an illustration corresponding to that of FIG. 5.

The device 1 according to the invention for rotational driving a part of a machine or a facility relative to a foundation or chassis or another part of a facility shows a particularly simple construction, namely a housing 2, wherein a worm 3 and a worm wheel 4 are pivoted in rotatable manner.

The plan view of the housing 2 according to FIG. 1 shows its two main segments, namely a first annular housing segment 6 concentrical to the swivel axis 5 of the rotational drive device 1, accommodating the worm wheel 4, as well as a second straight extending housing segment 7 for the accommodation of the worm 3.

The cross-sectional view in FIG. 4 indicates the structure of the annular housing segment 6: This has a sleeve-like geometry, substantially without a base or closure plate at its underside and without a lid on the upper side. As aberration from a pure cylindrical geometry, some stiffening ribs 9 parallel to the swivel axis are recognizable at the outer lateral surface 8, radially slightly broadening from the upper bearing's end face 10 to the lower bearing's end face 11 in cross-section and ending at the lower bearing's end face 11 in an encircling, flange-like extension 12. Thanks to these stiffening ribs, the thickness of the actual annular lateral surface 6 of the housing can be minimized.

Like visible in FIG. 2, the end face of the annular housing segment 6, preferably that with the encircling, flange-like extension 12, serves as plane connecting surface 13, to which a part of a facility or of a machine, a foundation, chassis or the like may be connected. Several bores, especially tapped blind holes 14, incorporated into this connecting surface 13 in an annularly distributed manner in parallel to the swivel axis 5 of the rotational drive device 1 serve to connect such part of a facility, etc. For receiving of these blind holes 14, the dimension parallel to the swivel axis 5 of the encircling, flange-like extension 12 is bigger than the depth of the blind holes 14, for example one and a half times as big or bigger.

The worm wheel 4 comprises a central recess 15 concentric to the swivel axis 5, and therefore also has a sleeve-like geometry without substantial radial elevations or indentations in its inner or outer lateral surface 16, 17. The inner lateral surface 16 is slightly conical, what facilitates the manufacture of the worm wheel as a cast part and thereby especially its demoulding ability. Thereby, in the mounted condition, the tapered region of the central recess 15 preferably faces the flange-like extension 12 of the annular housing segment 6 in an axial direction—that means at the opposite end face of the bearing—and shows a plane end face, which serves as connecting surface 18 for a part of a facility, etc. This connecting surface 18 comprises several bores annularly distributed around the swivel axis 5, especially tapped blind holes 19 in parallel to the swivel axis 5. Preferably, the depth of the blind holes 19 within the worm wheel 4 approximately corresponds with the depth of the blind holes 14 within the annular housing segment 6.

The worm wheel 4 has nearly the same axial extension as the housing 2, but it is slightly displaced relative to that in axial direction, so that always the regarding connecting surface 13, 18 protrudes slightly over the end face of the respectively other element—worm wheel 4 or connecting surface 13, 18 respectively—so that in case of a connection with a plane connecting surface of a part of a facility, etc., a scraping of the relatively rotatable part 4, 2 is impossible.

Between the inner side 20 of the annular housing segment 6 on the one hand and the outer laterals surface 17 of the worm wheel 4, there exists a gap 21, so that these parts can rotate relative to each other.

Two rolling contact bearings 22, 23 are arranged within the gap 21 for a rotatable bearing of the worm wheel 4 within the annular housing segment 6, one of which is located near the upper end face 10 of the bearing, while the other is situated in the region of the lower end face 11.

In FIG. 5, 6, the rolling contact bearings 22, 23 are illustrated in a highlighted manner to show the inner structure in a better way. As both rolling contact bearings 22, 23 have a substantially identical structure, they can be described in the following in common:

In both cases, ball bearings are concerned, that is to say rolling contact bearings 22, 23 with spherical rolling elements 24 having a diameter D. Both rolling contact bearing 22, 23 are angular rolling contact bearings or, respectively, angular contact ball bearings with an absolute value of the support angle |α| of 20° or more, for example of approximately 45°. The supporting angles α of both angular contact ball bearings are opposite to each other, that means positive on the one hand, and negative on the other hand, preferably ±α, so that one bearing 22 may absorb axial pressing forces, the other bearing 23 can absorb axial tension forces. Furthermore, both angular contact ball bearings 22, 23 are pre-stressed against each other, so that failing of a clearance in axial direction, there is no relative movement between worm wheel 4 and housing 2 in case of loads varying between axial tension and axial pressing.

A specialty of the bearings 22, 23 is that the raceways 25, 26 are directly machined, especially cut, into the (casted) base body of the regarding element—housing 2 or worm wheel 4. Furthermore, the raceways 25, 26 are preferably surface hardened to be able to sustain significant loads like frequent overrunning by the spherical rolling elements 24 for a term as long as possible without recognizable signs of wear.

The width W of the gap 21 may vary in axial direction, like apparent from FIG. 4. However, the minimum gap width Wₘᵢₙ along the entire gap 21 is at least similar or greater than half the diameter D of a rolling element 24:

Wₘᵢₙ≧D/2.

Thereby, it is ensured that the worm wheel 3 within the housing 2 can be displaced for at least d/2, as long as the rolling elements 24 are not yet positioned within the gap 21. By such a displacement, the gap 21 opens at one side: W≧D/2+D/2=D, while closing at the region situated diametrically opposite: W=D/2−D/2=0. Now, the rolling elements 24 may be inserted into the region of the raceways 25, 26 at the maximally opened site of the gap 21. After this has taken place, the rolling elements 24 are distributed along the circumferential direction, until finally they reside at equidistant positions, whereby the worm wheel 4 returns to a position concentric to the annular housing segment 6. At these equidistant positions, the rolling elements 24 are finally held by a cage 27 or by several cage segments per rolling contact bearing 22, 23. Preferably, the cage 27 has a comb-like structure with a rearward bridge or back 28 and with webs 29 protruding from that nearly parallel to each other within a common plane in the style of a comb's teeth.

However, due to the above described insertion procedure, the number Z of the rolling elements 24 per bearing 22, 23 is substantially smaller than the theoretical maximum value Z=U/D, with the pitch circle perimeter U, namely Z≦0.8*U/D, especially Z≦0.6*U/D. At Z=1/2*U/D, both adjacent rolling elements have a distance a in the magnitude of their diameter D: a=D. For this reason, webs 29 of the cage 27 have a relatively large extension in a longitudinal direction of the cage back 28. Therebetween, one can find indentations for receiving rolling elements 24, which follow a circular curve, preferably along a center angle of more than 180°, related to the center of the regarding rolling element 24. At such geometry, the webs 24 must be able to deform within a plane during the plugging onto the pre-positioned rolling elements 24. To facilitate this, it is further provided that, between two adjacent recesses, each for receiving a rolling element, the webs 29 of the cage 27 have at least one slit each, which gives an increased measure of flexibility to the cage 27.

Both bearings 22, 23 may be lubricated with grease as well as with oil, whereby the lubricant can contain metallic or non-metallic solid lubricants to avoid wear and jamming. The gap 21 is sealed in the area of both end faces 10, 11 of the bearing device beyond both rolling contact bearings 22, 23, to retain the lubricant within the gap 21 and at the same time protect it against contamination by intruding dirt and other particles.

These seals 30 may have the same structures, too, what, however, is not compulsory.

The illustrated seals 30 are each fixed to the housing 2, especially within a chamfer-like extension of the inner side 20 of the housing facing the gap 21. For this purpose, they possess a core 32 embedded in an elastic sealing material 31, in the form of a metal profile, especially of L-shaped cross-section, whereby the legs of this L-profile 32 running nearly orthogonally to each other stabilize themselves mutually and simultaneously press the rearward area of the elastic sealing material 31 against the inner side 20 of the housing.

Furthermore, one or, respectively, each sealing 30 is equipped with one or more sealing lips 33, 34, which are sliding along the outer lateral surface 17 of the worm wheel 4. The main sealing lip 33 facing the gap 21 is located at a cross-sectionally nearly V-shaped extension 35 of the elastic sealing material 31 in the area of the radially inner end of that leg of the L-shaped core 32 running transverse to the direction of the gap, especially at that flank of the core leg facing the gap. The tip of the extension 35 of V-shaped cross-section forms the main sealing lip 33 and points radially inwardly to the swivel axis 5. At that flank situated further outwardly, the V-shaped extension 35 forms a chamfer, wherein a tension wire 36 is seated, additionally pretensioning the sealing lip 33 inwardly, in the direction to the worm wheel 4.

A second, outer sealing lip 34 first of all serves as a dust seal and shall keep intruding particles away from the main sealing lip 33.

In the area of the outer lateral surface 17 of the worm wheel 4 between the both rolling contact bearings 22, 23, there are provided an external teeth system 37 with an encircling row of teeth 38 meshing with the thread 39 of the worm 3. Thereby, the area of the toothing 37 may be designed similar to a globoid wheel, that is a toothed wheel whose geared reference surface is a globoid, namely a rotational body whose lateral surface is generated by an arc of a circle rotating around an axis within the plane of the circle. This has the advantage that a greater part of a tooth 38 gets in contact with the worm 3; due to the enlarged contact area, bigger forces or, respectively, torques can be transferred. However, in some cases, a spur gear could be used with straight teeth, if the forces or, respectively, torques transferrable by that are sufficient.

Preferably, the worm 3 meshing therewith is formed as a cylindrical worm. However, it is also possible to use an hourglass worm, whose threaded reference surface is a globoid.

Furthermore, the worm 3 may be provided with a simplex toothing, whereby both flanks of the thread pitch, that are the flanks forward and rearward with regard to the longitudinal direction of the worm 3, have the same modules or, respectively, the same pitches, so that the cross-sectional geometry of the thread does not vary along its extension.

Such geometry is simple to manufacture; however, thereby often exists no possibility to compensate or adjust the clearance between tooth flanks. In contrast, the invention provides that the tooth flank clearance of the worm gear, that is the clearance between worm 3 and worm wheel 4, may be adjusted and/or readjusted. This may be achieved in the most elegant way by using a worm 3 with a so-called duplex toothing. This structure is characterized in that both flanks of the thread pitch, that are the flanks forward and rearward with regard to the longitudinal direction of the worm 3, have slightly different modules or, respectively, pitches, so that the cross-sectional geometry of the thread varies continuously along its extension.

Therefore, by a displacement of the worm 3 along its longitudinal axis, areas of the thread elevation with different width can be brought into meshing contact with the worm wheel 4, whereby the tooth flank clearance can be adjusted precisely.

Thereby, preferably, the area with narrower cross-section of the thread elevation is situated at the free end 40 of the worm 3, that is the non-driven end of the worm 3. In this way it is possible to insert the worm 3 into the cylindrical housing segment 7 thus far until the tooth flank clearance entirely vanishes, but just no increased friction or even jamming occurs. In this position, the worm 3 can then be pivoted.

The worm bearing illustrated in FIG. 3 serves for this purpose:

The forward or, respectively, free end 40 of the worm 3 is cylindrically shaped and is made longer than the rolling contact bearing 41 there, for example a needle bearing. Thereby, the worm 3 can be displaced in its longitudinal direction relative to this rolling contact bearing 41.

The rearward or, respectively, driven end 42 of the worm 3 comprises a gradation 43 between a proximal, thickened area 44 and a distal, tapered area 45 adjacent thereto. A for instance two-rowed rolling contact bearing 46, for example a double angular contact ball bearing, is slipped over this area 45. Within an encircling, groove- or notch-shaped recess 47 in the tapered shaft area 45, a lock ring 48 is inserted in alignment with that end face of the rolling contact bearing 46 near the driven side, so that the rolling contact bearing 46 is fixed onto the worm shaft 3 in an axially non-relocatable manner.

The outer ring(s) of the single-row or multiple-row rolling contact bearing 46 is/are incorporated within a sleeve 49 and are fixed therein in a similar, axially non-relocatable manner. For example, for this purpose, the sleeve 49 comprises at its inner end a collar 50 protruding inwardly, while an encircling recess 51 is provided at the inner side 52 of the sleeve 49 in alignment with that end face of this rolling contact bearing 46 near the driven side for insertion of a second lock ring 53, whereby the rolling contact bearing 46 is fixed to the sleeve 49 in an axially non-relocatable manner.

This sleeve 49 in turn is fixed to the open end face 54 of the elongated housing segment 7, for example screwed thereto. For this purpose, a radial outwardly projecting collar 56 may be provided at the peripheral or, respectively, outer end 55 of the sleeve 49. Therein, fixing bores parallel to the longitudinal axis of the worm shaft 3 are annularly distributed. These are each aligned with tapped blind holes 58 in the end face 54 of the elongated housing segment 7 and serve for passing fixing screws 59 through. By inserting spacer rings 60 of different thickness between the collar 56 of the sleeve 49 and the end face 54 of the elongated housing part 7, the axial position of the sleeve 49 can be varied and thereby the position of the worm shaft 3, too.

The above described usage of a duplex worm 3, where both flanks of the thread comprise slightly different modules or, respectively, pitches, results in both tooth flanks having different pitch angles, so that the thickness of or, respectively, the recess between elevations of the thread varies continuously along the toothed area of the worm. On the other hand, the thickness of and the recess between the teeth at the circumference of the worm wheel 4 remain constant. At the worm wheel 4, different modules of the worm 3 lead to different pitch circle diameters and therewith to different flank shapes at the forward and rearward flanks.

In this manner, the tooth flank clearance can be adjusted to any convenient value and may be sensitively and infinitely variably readjusted at any time, without significantly altering the meshing relationship of the toothing 37. A similar effect is achieved by a worm 3, whose reference surface is cut slightly conical.

Owing to the axially adjustable bearing of the worm shaft, the rotary clearance of the worm can be readjusted even then, when the swivel drive 1 is immovably installed within a facility. The readjustment is effected through a displaceable sleeve 49, which is fixed via a spacer ring; depending on the height of the spacer ring or, respectively, the set-up discs, the position of the worm 3 can be varied.

Furthermore, for control purposes, the worm 3 may be removed from the housing 2 along its longitudinal axis and/or may be replaced.

Typically, the housing 2 and/or the worm wheel 4 consist of a hardenable cast material, for example GGG-50.

The invention may be improved further in a manifold manner:

For example, a single-row or multiple-row ball or roller bearing can be provided for pivoting the worm wheel 4, preferably as double-row four point bearing or as angular ball bearing; even at an embodiment as roller bearing, the insertion of roller elements is possible through the gap 21.

At a multiple-row raceway system, the toothing of the worm wheel 37 does not have to be situated between the bearing raceways 22, 23, but could also be situated at one side thereof.

In case of heavy loads to transfer, the raceway system may be filled via fill bores in the housing 2 or in the worm wheel 4, so that a great number of roller elements is realizable. The fill bore is then closed by a plug and secured by pin or the like. In this way, roller elements may be inserted, which have a higher static and dynamic load capacity. The roller elements are then kept at narrow distances via a suitable cage or by intermediate pieces.

For increasing the load capacity, the surfaces of the bearing raceways 25, 26 are submitted to a heat treatment like inductive hardening or case hardening.

Furthermore, the raceways 25, 26 may be formed at preferably hardened annular segments, which are laid into a regarding groove or recess. The adjustment of the clearance or, respectively, of a pre-tension within the raceway system is effected by means of the selection of roller elements with a regarding diameter, whereby at multiple-row systems, roller elements of different size may be used for different rows of roller elements.

The worm wheel 4 carries a worm wheel toothing 37 at its circumference, which may be slightly greater in diameter as the outer diameter of the remaining areas of the worm wheel 4. However, even an elevated region of the toothing always has to be equal to or smaller than the inner diameter of the housing 2.

For control purposes, a lid srewable to the housing 2 opposite to the motor connection face 54 may be provided. There, a measuring device could be installed for data-acquisition above the rotation of the worm 3. Furthermore, for determining of the position, it would be possible to use the teeth of the worm wheel 4 sweeping past the housing 2 or to use other marks attached thereto. This can be done for example in an inductive manner by means of a bore in the housing 2, wherein an inductive proximity switch could be arranged. In such cases, one or more additional marks or special marked teeth could serve for determination of a zero point reference position.

### Reference Numerals

1 device

2 housing

3 worm

4 worm wheel

5 swivel axis

6 housing area

7 housing area

8 lateral surface

9 stiffening rib

10 bearing's end face

11 bearing's end face

12 flange-like extension

13 connecting surface

14 blind hole

15 recess

15 lateral surface

16 lateral surface

17 connecting surface

18 blind hole

19 inner surface

20 gap

21 rolling contact bearing

22 rolling contact bearing

23 roller element

25 raceway

26 raceway

27 cage

28 back

29 web

30 sealing

31 sealing material

32 core

33 sealing lip

34 sealing lip

35 projection

36 tension wire

37 external toothing

38 tooth

39 thread

40 free end

41 rolling contact bearing

42 driven end

43 increment

44 thickened area

45 tapered area

46 rolling contact bearing

47 recess

48 lock ring

49 sleeve

50 collar

51 recess

52 inner surface

53 lock ring

54 end face

55 end

56 collar

57 fixing bore

58 blind hole

59 fixing screw

60 spacer ring

1. A device (1) for a rotary drive of a part of a machine or a facility, including a crane, an elevating working platform, a tracking photovoltaic assembly, and a heliostat, or like equipment, for tracking mirrors within the context of a solar thermal power station, relative to a supporting foundation or chassis portion of a heavy duty vehicle, or relative to another part of a machine or of a facility, the device comprising a worm gear mechanism having a housing (2), provided with a connecting surface for connecting to a part of a machine or a facility, to a chassis or to a foundation, and a worm (3), rotatable manually, or by means of a drive motor, and a worm wheel (4) rotatably mounted in the housing (2), wherein there is provided at least one rolling contact bearing on each of both sides of a toothing of the worm wheel (4), provided to engage with the worm (3), and which comprises a connecting surface for connecting to a part of the machine or the facility, to a chassis, or to a foundation, which is accessible via a central opening of the housing (2), wherein at least an area of the housing (2) which is concentric to the swivel axis of the device swivel drive, is formed in one piece, wherein the smallest internal diameter of the housing (2) is larger than the largest external diameter of the worm wheel (4).

2. The device (1) according to claim 1, wherein the housing (2) and/or the worm wheel (4) comprises a cast part.

3. The device (1) according to claim 1, wherein the worm wheel (4) comprises a central recess (15), and the central recess (15) traverses the worm wheel (4) entirely.

4. The device (1) according to claim 3, wherein an inner surface (16) of the central recess (15) in the worm wheel (4) defines a conical course.

5. The device (1) according to claim 2, wherein raceways (25, 26) of the worm wheel (4) for rolling elements (24) are fabricated out of a same base body as external toothing (37) thereof.

6. The device (1) according to claim 5, wherein the toothing (37) of the worm wheel (4) is adapted to the cross-section of the worm (3) by an hourglass toothing configuration.

7. The device according to claim 1, wherein a minimum cross-sectional area of the worm wheel (4) in a meshing region is smaller than a connecting surface (18).

8. The device according to claim 1, wherein connecting surface(s) (13, 18) of the housing (2) and/or of the worm wheel (4) are planar, and the connecting surface(s) (13, 18) of the housing (2) and the worm wheel (4) lie in planes parallel to one another.

9. The device according to claim 8, wherein at the connecting surface(s) (13, 18) of the housing (2) and/or of the worm wheel (4), annularly distributed fixing elements are provided for the fixation to a part of a machine or a facility, to a foundation or chassis.

10. The device according to claim 9, wherein the fixing elements connecting surface(s) (13, 18) are shaped as through-bores or as tapped blind holes (14,19).

11. The device according to claim 10, wherein in a bottom of a blind hole (14, 19) is disposed at a row of the roller elements (24).

12. The device according to claim 1, and further comprising two angular contact ball bearings, arranged as a double angular rolling contact bearing comprising a double angular contact ball bearing.

13. The device according to claim 5, wherein the raceways (25, 26) are surface-hardened.

14. The device according to claim 5, wherein the rolling elements (24) are held at equidistant positions by cage means (27).

15. The device according to claim 14, wherein the cage (27) means comprise a two-dimensional, comb-like structure, whereby free ends of a comb's teeth (29) of both rolling contact bearings (22, 23) are directed vis-à-vis.

16. The device according to claim 5, wherein a minimum width (Wₘᵢₙ) of a gap (21) between the radially outer end face of the worm wheel (4) and an inner surface (20) of the housing (2, 6) is equal to, or greater than, half the value of the diameter (D) of a rolling element (24).

17. The device according to claim 16, wherein the gap (21) between the housing (2, 6) and the worm wheel (4) is sealed at both end faces (10, 11) of the rolling contact bearing.

18. The device according to claim 17, wherein at least one sealing means (30) is configured as a radial shaft seal.

19. The device according to claim 18, wherein the at least one sealing means (30) comprises a sealing lip (33), which is pressed against a thrust surface by means of a circumferential tension wire (36).

20. The device according to claim 16, wherein an outer lateral surface (8) of the housing (6) surrounding the worm wheel (4) follows a conical course, with attached stiffening ribs (9) and/or with a circumferential, flange-like extension (12), in an area of a connecting surface (13).

21. The device according to claim 1, wherein a lateral projection (7) is provided at the housing (2, 6) for receiving the worm (3).

22. The device according to claim 21, wherein the worm (3) is pivoted within the lateral housing projection (7) by means of rolling contact bearings (41, 46).

23. The device according to claim 22, wherein the position of the worm (3) within the lateral housing projection (7) is variable in a longitudinal direction.

24. The device according to claim 1, wherein the geometry of the worm (3), and/or of a worm thread, varies in the longitudinal direction of the worm (3).

25. The device according to claim 24, wherein a distance between flanks of the worm thread varies along a longitudinal direction of the worm (3).
